(19) United States
(12) Patent Application Publication
(10) Pub. No.: US 2012/0047541 A1
(43) Pub. Date: Feb. 23, 2012

(54) CONTENT MEDIATION SERVER, CONTENT PLAYBACK DEVICE, AND CONTENT PLAYBACK SYSTEM

(76) Inventor: Yasuyuki Noda, Kawasaki-shi (JP)

(21) Appl. No.: 13/318,192

(22) PCT Filed: Apr. 30, 2009
(86) PCT No.: PCT/JP2009/058485

§ 371 Date: Oct. 31, 2011

(51) Int. Cl. H04N 21/20

(52) U.S. Cl. 725/91

(57) ABSTRACT

A content mediation server 5 includes means that collectively registers a video content in each of a plurality of content providing servers 2 in response to receiving an upload request from a content registration device 3; a storage means that stores therein registration information to be correlated with the video content, the registration information including a format and a registration-destination of the video content when the specified video content is collectively registered in each of the plurality of content providing servers 2; means that refers to the storage means in response to receiving, from a content playback device 4, a retrieval request for retrieving a video content that is identical to a specified video content, to obtain corresponding registration information; and means that transmits, to the content playback device, the obtained registration information as a retrieval response.

### TECHNICAL FIELD OF THE INVENTION

The present invention relates to technologies that retrieve desired video images in published video images in a video-sharing site, and playback them.

### BACKGROUND ART

Recently, video-sharing sites, such as YouTube, are popularly used. Video images published in such a video-sharing site can be viewed with a television set having an internet access function.

### DISCLOSURE OF THE INVENTION

### Problems to be Solved by the Invention

However, image quality may be reduced in viewing a video image in a video-sharing site with a television set having the internet access function. In addition, it may be difficult to play back a video image in a video-sharing site on a television set having the internet access function. These are because video formats supported by the video-sharing site and those supported by the television set are different from each other. For example, there is a case where low-resolution video images are supported by the video-sharing site while high-resolution video images are supported by the television set. There is also a case where a hardware decoder installed in the television set does not support video formats supported by the video-sharing site.

In these cases, if a same video image exists in another video-sharing site, the video-sharing site supports a higher-quality resolution and a format that can be played back on the television set, the video image in the video-sharing site can be played back. However, it may be difficult to find out a same video image in many video-sharing sites. Although a video image can be retrieved using a keyword and/or its title, you can finally identify that a video image is the same as a video image to be viewed only when actually viewing the video image.

The present invention has been made to solve the aforementioned circumstances, and has an example of a purpose of easily retrieving a video image, which is the same as a video image to be viewed, and playing back a video image in its optimum format.

### Means for Solving the Problems

In order to achieve such a purpose provided above, a first aspect of the present invention is a content mediation server mutually communicable with: a plurality of content providing servers for providing video contents; and a content playback device for playing back video contents provided from the plurality of content providing servers, via a communication network, the content mediation server including: a content registration means that collectively registers a specified video content in each of the plurality of content providing servers; a registration information storage means that stores therein registration information to be correlated with the specified video content, the registration information including a format and a registration-destination of the specified video content when the specified video content is collectively registered in each of the plurality of content providing servers; a retrieval request receiving means that receives, from the content playback device, a retrieval request including identifying information for uniquely identifying a video content; a retrieval means that retrieves the registration information storage means according to the received retrieval request to obtain the registration information associated with a video content that is identical to the video content identified by the identifying information; and a retrieval response transmitting means that transmits, to the content playback device, the registration information obtained by the retrieval information as a retrieval response.

A second aspect of the present invention is a content playback device mutually communicable with: a plurality of content providing servers for providing video contents; and a content mediation server including a registration information storage means, when a video content is collectively registered in each of the plurality of content providing servers, the registration information storage means storing therein registration information to be correlated with the registered video content, the registration information including a format and a registration-destination of the registered video content, the content mediation server including: a retrieval request transmitting means that transmits, to the content mediation server, a retrieval request including identifying information for uniquely identifying a video content; a retrieval response receiving means that retrieves the registration information storage means according to the retrieval request, and receives, from the content mediation server, registration information as a retrieval response, the registration information being associated with a video content that is identical to the video content identified by the identifying information; a server select means that selects a content providing server according to the registration information of the received retrieval response and a format playable by the content playback device; and a content playback means that plays back a video content in the content providing server in accordance with the registration information of the selected content providing server.

A third aspect of the present invention is a content playback system including: a plurality of content providing servers for providing video contents; a content registration device for registering video contents in the plurality of content providing servers; a content playback device for playing back video contents provided from the plurality of content providing servers; and a content mediation server for mediating information between the plurality of content providing servers and the content registration device, and between the plurality of content providing servers and the content playback device, the devices being mutually communicable with each other, wherein the content mediation server including: an upload request receiving means that receives an upload request from the content registration device, the upload request being configured to include a specified video content and collectively register the specified video content in each of the plurality of content providing means; a content registration means that collectively registers the specified video content in each of the plurality of content providing servers in response to receiving the upload request; a registration information storage means that stores therein registration information to be correlated with the specified video content, the registration information including a format and a registration-destination of the specified video content when the specified video content is collectively registered in each of the plurality of content providing servers; a retrieval request receiving means that receives, from the content playback device, a retrieval request including identifying information for uniquely identifying a video content; a retrieval means that retrieves the registration information storage means according to the retrieval request to obtain the registration information associated with a video content that is identical to the video content identified by the identifying information; and a retrieval response transmitting means that transmits, to the content playback device, the registration information obtained by the retrieval information as a retrieval response, and the content playback device including: a retrieval request transmitting means that transmits, to the content mediation server, the retrieval request; a retrieval response receiving means that receives, from the content mediation server, the retrieval response; a server select means that selects a content providing server according to the registration information of the received retrieval response and a format playable by the content playback device; and a content playback means that plays back a video content in the content providing server in accordance with the registration information of the selected content providing server.

### BRIEF DESCRIPTION OF THE DRAWINGS

FIG. 1 is a schematic structural view of a content playback system according to an embodiment of the present invention;

FIG. 2 is a functional-structural view of a content mediation server of the content playback system according to the embodiment of the present invention;

FIG. 3 is a functional-structural view of a content playback device of the content playback system according to the embodiment of the present invention;

FIG. 4 is a view illustrating an example of user data of the content playback system according to the embodiment of the present invention;

FIG. 5 is a view illustrating an example of server data of the content playback system according to the embodiment of the present invention;

FIG. 6 is a view illustrating an example of content registration data of the content playback system according to the embodiment of the present invention;

FIG. 7 is a view illustrating an example of network environmental data of the content playback system according to the embodiment of the present invention;

FIG. 8 is a flowchart indicative of a content batch registering task of the content playback system according to the embodiment of the present invention;

FIG. 9 is a flowchart indicative of a content retrieving task of the content playback system according to the embodiment of the present invention; and

FIG. 10 is a flowchart indicative of a content playback task of the content playback system according to the embodiment of the present invention.

### EMBODIMENTS FOR CARRYING OUT THE INVENTION

An embodiment of the present invention will be described hereinafter with reference to the drawings.

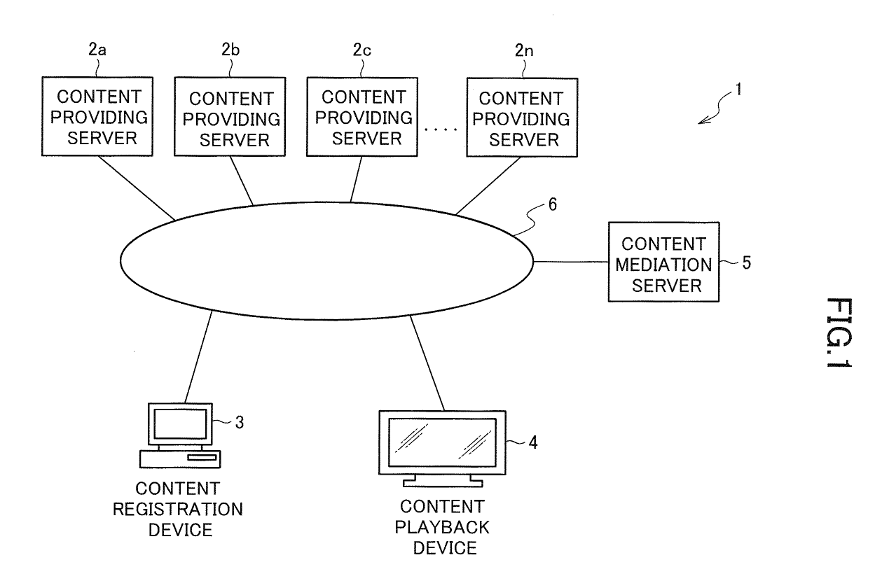

FIG. 1 is a schematic structural view of a content playback system 1 according to an embodiment of the present invention. The content playback system 1 includes a plurality of content providing servers 2a, 2b, 2c, . . . , 2n. For describing a content providing server generically, they will be expressed as a content providing server 2. The content playback system 1 includes a content registration device 3 that registers video contents in the content providing server 2, and a content playback device 4 that plays back video contents provided by the content providing server 2. The content playback system 1 includes a content mediation server 5 that mediates between the content providing server 2 and the content registration device 3, and between the content providing server 2 and the content playback device 4. The content playback system 1 includes a communication network, such as the Internet, 6 that allows the devices to mutually communicate with each other.

The content providing server 2 is a server installed in, for example, a video-sharing site, which publishes video contents uploaded by users and makes the uploaded video contents available.

The content registration device 3 is a device for uploading user's video contents to the content providing server 2. For example, a personal computer can be used as the content registration device 3. In this embodiment, as mentioned later, video images are collectively uploaded to the content providing servers 2 via the content mediation server 5.

The content playback device 4 is a device that plays back video contents provided by the content providing server 2. For example, a television set connectable to the communication network 6 can be used as the content playback device 4. In this embodiment, when the content playback device 4 plays back a desired video content published in a video-sharing site, a content providing server 2 storing the desired video content and formats supported thereby are retrieved by the content mediation server 5 to be informed to the content playback device 4. For this reason, the content playback device 4 is adapted to select an optimum content providing server 2 in a result of the retrieval, and access the selected content providing server 2 to play back a video content.

When the content registration device 3 registers video contents in the content providing servers 2, the content mediation server 5 is adapted to carry out a content batch registering task that mediates between the content providing servers 2 and the content registration device 3 to register video contents in the content providing servers 2.

The content mediation server 5 is also adapted to carry out a content retrieving task that mediates between the content providing servers 2 and the content playback device 4 to retrieve a content providing server 2 that stores therein a video content that is the same as a video content to be played back. Note that, in this embodiment, services that the content mediation server 5 carry out will be referred to as content mediation services.

Next, the content mediation server 5 and content playback device 4, which play a role for the content batch registering task and the content retrieving task will be described.

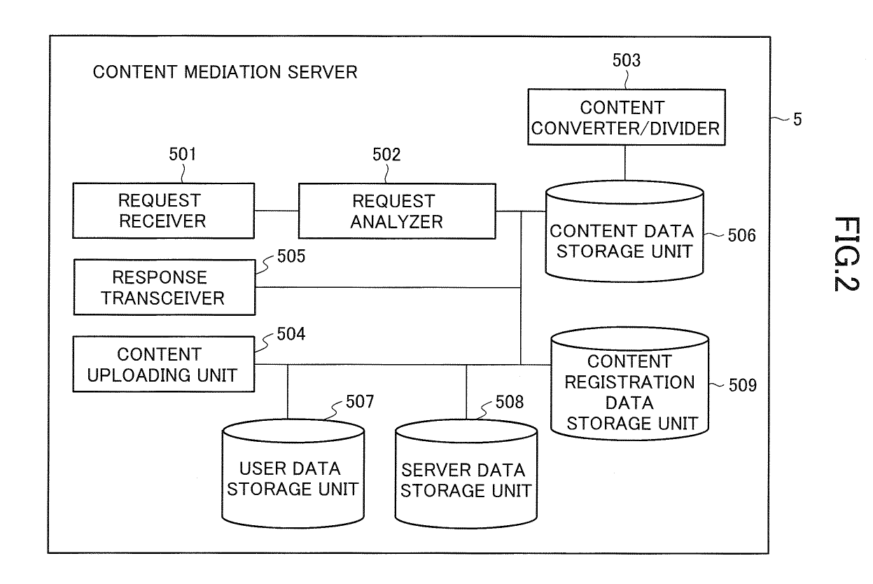

FIG. 2 is a functional-structural view of the content mediation server 5. Referring to FIG. 2, the content mediation server 5 includes a request receiver 501, a request analyzer 502, a content converter/divider 503, a content uploading unit 504, a response transceiver 505, a content data storage unit 506, a user data storage unit 507, a server data storage unit 508, and a content registration data storage unit 509.

The request receiver 501 is adapted to receive upload requests sent from the content registration device 3 and retrieval requests sent from the content playback device 4.

The upload requests are requests issued when the content registration device 3 uploads video contents to the content servers 2. Specifically, an upload request consists of: a user ID for taking advantage of the content mediation service; content data of a corresponding video content; metadata of the video content, such as its title, a list for indicating a content providing server 2 as upload-destination, and the like; the list will be referred to as a server list L1.

A retrieval request is a request issued when the content playback device 4 plays back a video content published in a video-sharing site. Specifically, a retrieval request is a retrieval condition that consists of access information for accessing a video content to be played back, such as corresponding URL (Uniform Resource Locator). That is, in viewing a desired video content published in a video sharing site, a user must inform the content mediation server 5 of at least one piece of whereabouts information of the desired video content. Note that, in this embodiment, URL is used as the retrieval information, but it is not limited thereto. Information uniquely identifying a video content to be retrieved, such as its title, can be used as the retrieval information.

The request analyzer 502 is adapted to analyze a request received by the request receiver 501, thus performing a process according to the received request.

For example, when receiving an upload request, the request analyzer 502 performs preprocessing to upload a corresponding video content to the content providing servers 2. Specifically, the request analyzer 502 temporarily stores the content data of the video content in the content data storage unit 506, determines whether there is a need to divide or convert in format the video content when uploading it to each content providing server 2, and request the content converter/divider 503 to perform a task of converting in format the video content or dividing the video content.

As another example, when receiving a retrieval request, the request analyzer 502 refers to the content registration data storage unit 509 to retrieve a content providing server 2 that stores therein a video content that is the same as the video content of the retrieval condition, and obtains content registration data d30 associated with the content providing server 2 that meets the retrieval condition, thus creating a retrieval response. The content registration data d30 and the retrieval response will be described in detail later.

The content-data converter/divider 503 is adapted to convert the formal of a video content into a formal supported by a content providing server 2, or divide a video content into the maximum capacity of a content providing server 2. Note that a video content with a converted format or divided video contents are temporarily stored in the content data storage unit 506.

The content uploading unit 504 is adapted to collectively upload video contents to the content providing servers 2. Note that, if a content providing server 2 as upload-destination needs a video content with a converted format or divided video contents, a video content with its format being converted by the content converter/divider 503 or video contents divided thereby is or are uploaded to the content providing server 2.

The response transceiver 505 is adapted to transmit a retrieval response created by the request analyzer 502 to the content playback device 4 when receiving a retrieval request.

The content data storage unit 506 stores thereinto the content data of a video content when receiving an upload request, and temporarily stores thereinto a video content with its format being converted by the content converter/divider 503 or video contents divided thereby.

The user data storage unit 507 stores therein user data d10 that is obtained by correlating: user IDs that uniquely identify corresponding users for using the content mediation service with combinations of user IDs and corresponding passwords required to use each content providing server 2. The user data d10 is used for the content uploading unit 504 to video contents to respective content providing servers 2.

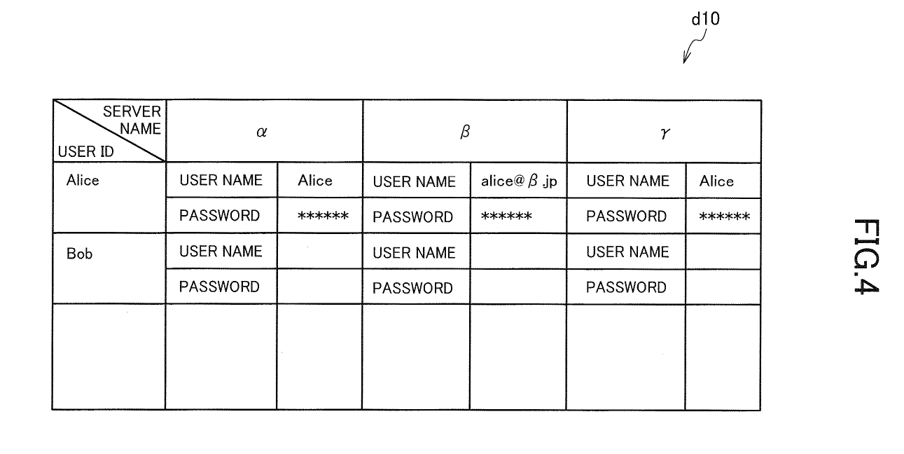

FIG. 4 illustrates an example of the user data d10.

The server data storage unit 508 stores therein server data d20 for each content providing server 2; the server data d20 manages supported formats of video contents, uploading procedures, and so on.

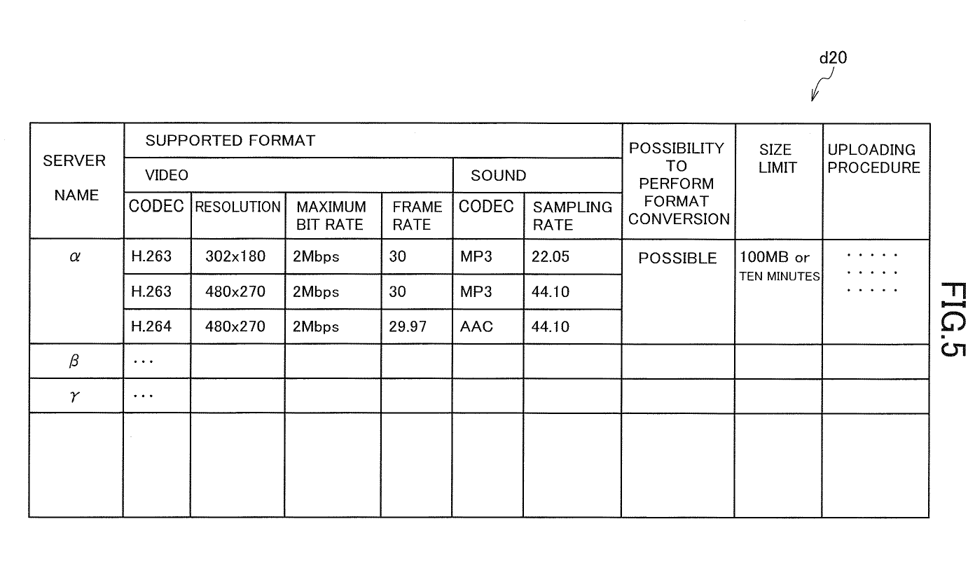

FIG. 5 illustrates an example of the server data d20. Specifically, as illustrated in FIG. 5, the server data d20 consists of, for each content providing server, supported formats (video formats and sound formats), possibility to perform format conversion, size limit, uploading procedure, and so on. The supported formats represents information associated with video formats each including codec, resolution, maximum bit rate, frame rate, and so on, and associated with sound formats each including codec, sampling rate, and so on. The possibility to perform format conversion represents whether it is possible for the corresponding content providing server 2 to perform format conversion of video contents.

If the original format of a video content is not supported by a content providing server 2 to which the video content is to be uploaded, and the server data d20 of the corresponding content providing server 2 represents that the format conversion is not possible, format conversion of a video content by the content converter/divider 503 is needed when the video content is uploaded to the corresponding content providing server 2.

The size limit represents information associated with the maximum capacity if there is a size limit for each content. If the capacity of a video content exceeds the maximum capacity, division of the video content by the content converter/divider 504 is needed.

The uploading procedure represents information stored in program function or script and associated with the procedure required to register a video content in the corresponding content providing server 2; the information includes the URL of the corresponding content providing server 2.

The content registration data storage unit 509 stores therein content registration data d30 consisting of an access destination and a format when the content uploading unit 504 uploads a video content to each content providing server 2.

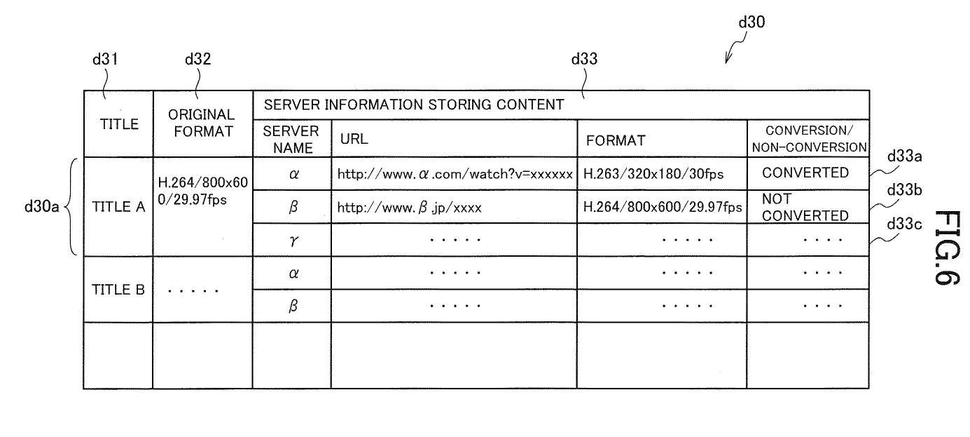

FIG. 6 illustrates an example of the content registration data d30. Specifically, as illustrated in FIG. 6, the content registration data d30 consists of items including the title d31 and the original format d32 of each registered video content, and server information d33 of at least one content providing server 2 that stores each registered video content. The original format is comprised of a corresponding video format including codec, resolution, frame rate, and so on, and a corresponding sound format including, not shown, codec, sampling rate, and so on.

The server information d33 consists of, for at least one server 2 that registers each registered video content, the server name; the URL of a corresponding uploaded video content as access destinations; and the format of a corresponding uploaded video content comprised of a corresponding video format including codec, resolution, frame rate, and so on, and a corresponding sound format including, not shown, codec, sampling rate, and so on. In addition, the server information d33 consists of, for at least one server 2 that registers each registered video content, flag information representing that the original format of a corresponding video formal has been converted. Note that, if a video content is uploaded while being divided, the URLs of the respective divided video contents as their access destinations are stored in the item of “URL” in the order of playback of the divided video contents.

For example, content registration data 30a illustrated in FIG. 6 represents that the codec, resolution, and frame rate of the original format of a video content whose title is A are respectively H.264, 800×600 and 29.97 fps, and the video content whose title is A has been uploaded to the content registration servers 2 whose server names are α, β, and γ. A piece d33a of the server information d33 of the content registration data d30a represents registration information of the content registration server 2 whose server name is α, the URL, the codec of the registered format, the resolution, and the frame rate of a corresponding registered video content are respectively http://www.α.com/watch?=xxxxxx, H.263. 320×180, and 30.0 fps, and the original format of the corresponding registered video content has been converted.

Thus, specifically, when receiving a retrieval request, the request analyzer 502 is adapted to obtain content registration data d30 that stores therein a URL that is the same as the URL included in the retrieval request as a result of retrieval. For example, if a retrieval request includes, as URL information, http://www.α.com/watch?=xxxxxx, data including the content registration data d30a is created as a retrieval response.

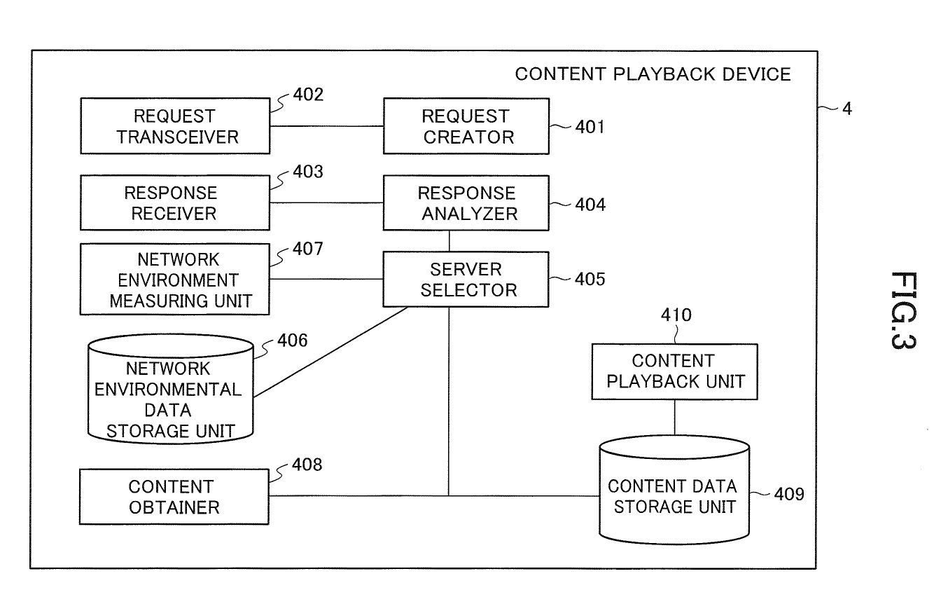

FIG. 3 is a functional-structural view of the content playback device 4. Referring to FIG. 3, the content playback device 4 includes a request creator 401, a request transceiver 402, a response receiver 403, a response analyzer 404, a server selector 405, a network environmental data storage unit 406, a network environment measuring unit 407, a content obtainer 408, a content data storage unit 409, and a content playback unit 410.

The request creator 401 is adapted to create a retrieval request for playing back a video content. As described above, the retrieval request includes the access information, such as the URL and the like, of the video content to be viewed by a user.

The request transceiver 402 is adapted to transmit, to the content mediation server 5, the created retrieval request.

The response receiver 403 is adapted to receive a retrieval response as a result of retrieval of a retrieval request from the content mediation server 5. Note that a retrieval response includes the content registration data illustrated in FIG. 6.

The response analyzer 404 is adapted to analyze a received retrieve response to perform a task according to the contents of the received retrieve response. Specifically, the response analyzer 404 determines whether there is a content providing server 2, which stores therein video contents whose formats can be played back by the content playback device 4, in the server information d33 included in the retrieve response. If there is a content providing server 2, referred to as a “playable-content providing server 2”, which stores therein video contents whose formats can be played back by the content playback device 4, in the server information d33, the response analyzer 404 requests the server selector 405 to perform a task to select an optimum content providing server 2. Otherwise, if there are no playable-content providing servers 2, the response analyzer 404 creates an unplayable message, and displays the created unplayable message on the screen of the content playback device 4.

The network environmental data storage unit 406 stores therein network environmental data d40 representing the current condition of the communication environments in accessing the content providing servers 2, in other words, representing the accessibility to the content providing serves 2.

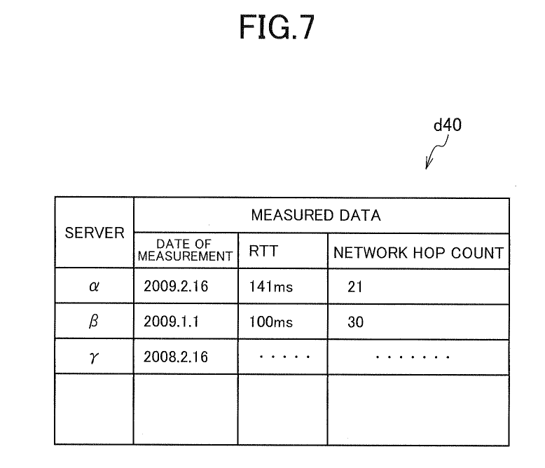

FIG. 7 illustrates an example of the network environmental data d40. Specifically, as illustrated in FIG. 7, the network environmental data d40 consists of, for each content providing server 2, terms including: date of measurement, RTT (Round Trip Time), hop count, and so on. The RTT represents time taken from the transmission of a packet by the content playback device 4 to the return, to the content playback device 4, of a response created when the packet arrives at a corresponding content providing server 2. The hop count represents the number of routers (networks) through which a packet transmitted from the content playback device 4 passes until the packet arrives at a corresponding content providing server 2.

The network environment measuring unit 407 is adapted to measure network environmental data d40 of a content providing server 2 in response to an instruction of measurement of network environmental data from the server selector 405 if recent network environmental data d40, such as network environmental data d40 measured within one week before today, is not stored. The measured network environmental data d40 is stored in the network environmental data storage unit 406.

The server selector 405 is adapted to create a list, referred to as a sever list L2 hereinafter, associated with playable-content providing servers 2, and set priority in content providing servers 2 included in the server list L2. In addition, the server selector 405 is adapted to select a playable-content providing server 2 with the highest priority as an optimum content providing server 2.

Specifically, if there are playable-content providing servers 2, the server selector 405 selects content providing servers 2 having video contents in their original formats, sorts the selected content providing servers 2 in descending order of network environment, and selects the highest-priority content providing server 2. Note that, if there are no content providing servers 2 having video contents in their original formats, the server selector 405 sets priority in content providing servers 2 in consideration of degree of similarity compared to original format, image quality, network environment, and so on, and selects the highest-priority content providing server 2.

Note that the server selector 405 refers to the network environmental data d40 stored in the network environmental data storage unit 406 to thereby determine the network environment. However, if recent network environmental data d40, such as network environmental data d40 measured within one week before today, is not stored in the network environmental data storage unit 406, the server selector 405 requests the network environment measuring unit 407 to measure network environmental data d40.

Note that the aforementioned rule for establishing priority in content providing servers 2 included in the server list L2 is a preferable example, and a rule for establishing priority in content providing servers 2 included in the server list L2 is not always limited to the aforementioned rule.

The content obtainer 408 is adapted to access the content providing server 2 selected by the server selector 405 to obtain a video content, thus storing it in the content data storage unit 409. Specifically, the content obtainer 408 refers to the server information d33 included in a retrieval response to obtain the URL of a video content, and accesses a video content of the content providing server 2 selected by the server selector 405 to obtain the video content.

Note that, if the content obtainer 408 tries to obtain a video content from the content providing server 2 selected by the server selector 405 but cannot obtain it, the server selector 405 selects the next-priority content providing server 2, and the content obtainer 408 obtains a video content from the next ordered content providing server 2.

The content data storage unit 409 stores therein video contents obtained by the content obtainer 408 for playback of them.

The content playback unit 410 is adapted to play back a video content stored in the content data storage unit 409. In this embodiment, the content playback unit 410 uses a method of playing back a video content after downloading the entire of the video content, but video-content playback method is not limited to the method. Specifically, while obtaining the video content, the content obtainer 408 can simultaneously play back the obtained video content.

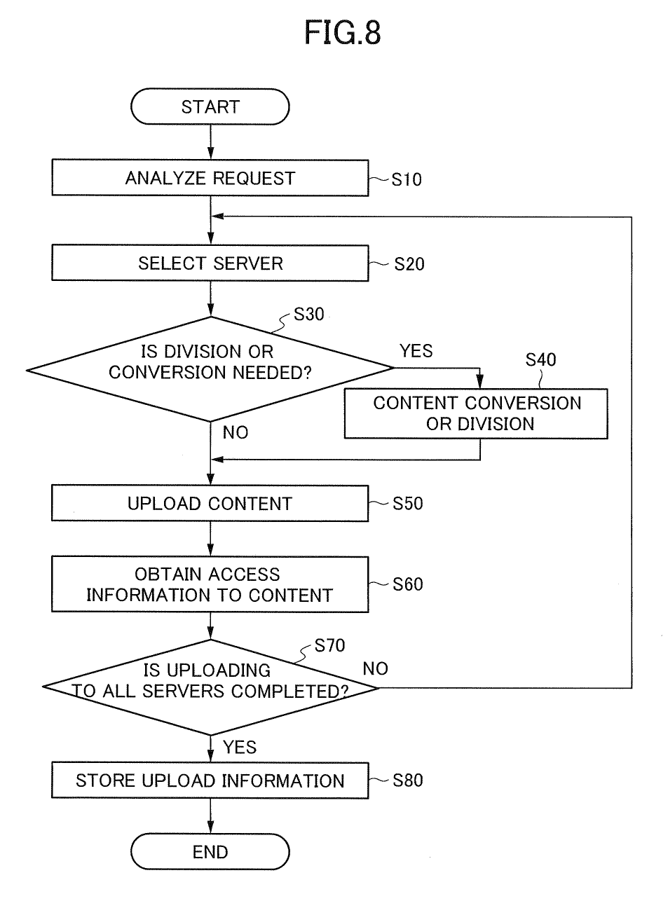

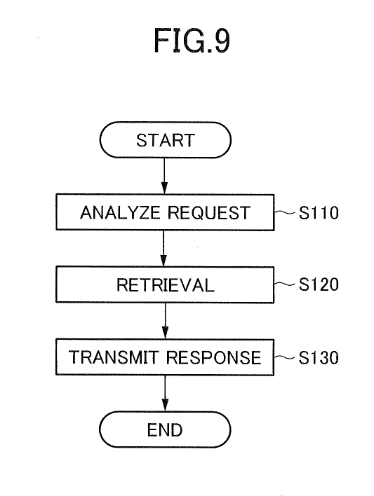

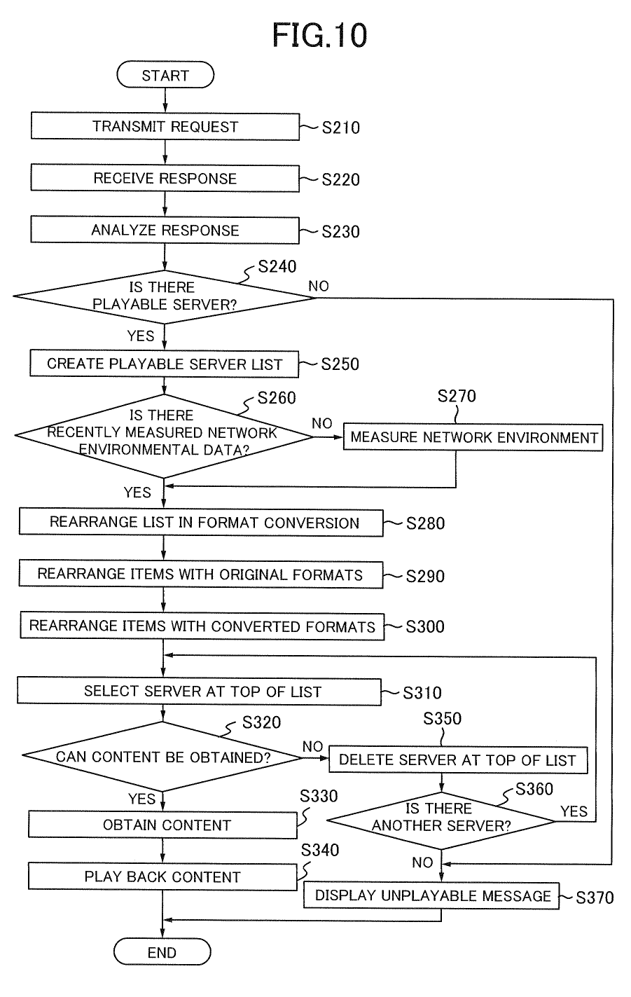

Next, operations of the content playback system 1 according to this embodiment will be described with reference to FIGS. 8 to 10. FIG. 8 is a flowchart illustrating a flow of operations of the content mediation server 5 for carrying out the content batch registering task in response to receiving an upload request from the content registration device 3. FIG. 9 is a flowchart illustrating a flow of operations of the content mediation server 5 for carrying out the content retrieving task in response to receiving a retrieval request from the content playback device 4. FIG. 10 is a flowchart illustrating a flow of operations of the content playback device 4 in a period from the transmission of a retrieval request to the content mediation server 4 to the playback of a video content in response to receiving a retrieval response.

First, the content batch registering task will be described with reference to FIG. 8.

When receiving an upload request from the content registration device 3, the content mediation server 5 analyzes the upload request in step S10. Specifically, the content mediation server 5 extracts various parameters included in the upload request, which includes the user ID, the content data of the video content, the metadata of the video content, the server list L1 in which at least one content providing server 2 is described as upload-destination, and so on. Then, the content mediation server 5 stores the content data of the video content in the content data storage unit 506.

Next, the content mediation server 5 selects a content providing server 2 in the server list L1 in step S20.

Subsequently, the content mediation server 5 determines whether there is a need to divide or convert in format the video content when uploading it to the selected content providing server 2 in step S30. Specifically, the content mediation server 5 performs the determination by comparing the data capacity and the original format of the video content to be uploaded with the server data d20 corresponding to the selected content providing server 2 and stored in the server data storage unit 508.

If it is determined that there is a need to divide or convert in format the video content (YES in step S30), the content mediation server 5 converts the format of the content into a format supported by the content providing server as upload destination as upload-destination, or performs division of the content so as to meet the size limit for each content of the content providing server 2 as upload-destination in step S40.

The content mediation server 5 accesses the content providing server 2 as upload-destination in accordance with the upload procedure of the server data d20 stored in the server data storage unit 508, thus uploading the video content thereto in step S50. When uploading the video content, the content mediation server 5 uses the user data d10 stored in the user data storage unit 507, which includes the user ID and password required to log into the content providing server 2 as upload-destination.

If content conversion or content division has not been performed (NO in step S30), the content mediation server 5 uploads the content data itself transmitted from the content registration device 3. Otherwise, if content conversion or content division has been performed (YES in step S30), the content mediation server 5 uploads content data whose format is converted, or uploads divided pieces of content data.

Next, upon completion of the upload of the video content, the content mediation server 5 obtains, from the content providing server 2 to which the video content has been uploaded, the access information, such as the URL, the format, and so on, for accessing to the uploaded video content in step S60. Note that, if divided video content have been uploaded, the content mediation server 5 obtains the access information, such as the URL, the format, and so on, for accessing to each of the divided video contents.

Subsequently, the content mediation server 5 determines whether the upload of the video content to all of the content providing servers 2 included in the server list L1 is completed in step S70. If there are one or more content providing servers 2 to which uploading is not completed (NO in step S70), the content mediation server 5 uploads the video content to the one or more content providing servers 2 to which uploading is not completed (see steps S20 to S60).

If the upload of the video content to all of the content providing servers 2 included in the server list L1 is completed (YES in step S70), the content mediation server 5 creates content registration data d30 of the uploaded video content, and stores the content registration data d30 in the content registration data storage unit 509 in step S80.

Next, the content retrieving task will be described with reference to FIG. 9.

When receiving a retrieval request from the content playback device 4, the content mediation server 5 analyzes the retrieval request, and extracts various parameters included in the retrieval request, which includes the URL as retrieval condition in step S110. Note that the retrieval request is information including the URL of a video content that a user wants to view, and is created by the content playback device 4 according to a user's instruction.

Next, the content mediation server 5 refers to the content registration data d30 stored in the content registration data storage unit 509 in accordance with the retrieval condition of the retrieval request, thus finding out the content registration data d30 storing therein the URL that is the same as the URL of the retrieval condition in step S120.

Next, the content mediation server 5 creates a retrieval response based on a result of the retrieval, and transmits the retrieval response to the content playback device 4 that has transmitted the retrieval request in step S130. Note that the retrieval response includes the content registration data d30 storing therein the URL that is the same as the URL of the retrieval condition.

Next, a content playback task will be described with reference to FIG. 10.

The content playback device 4 creates a retrieval request, and transmits the created retrieval request to the content mediation server 5 in step S210.

Next, the content playback device 4 receives a retrieval response corresponding to a retrieval request in step S220, and analyzes the received retrieval response in step S230. Specifically, the content playback device 4 refers to the content registration data d30 included in the retrieval response to extract the original format d32 of the corresponding video content and the server information d33.

Subsequently, the content playback device 4 determines whether there is a playable-content providing server 2 in the extracted server information d33 in step S240. Specifically, the content playback device 4 refers to the server information d33 included in the retrieval response to determine whether there are one or more formats playable by its own device. If there is a format playable by its own device, the content playback device 4 determines that there is a playable-content providing server 2.

If there is a playable-content providing server 2 (YES in step S240), the content playback device 4 creates a server list L2 in step S250.

Otherwise, there are no playable-content providing servers 2 (NO in step S240), the content playback device 4 displays an unplayable message on the screen thereof in step S370, terminating the task.

Next, the content playback device 4 determines whether the network environmental data d40 of each content providing server 2 included in the server list L2 was recently measured, for example, was measured within one week before today in step S260.

If the recently measured network environmental data d40 of a content providing server 2 is not present (NO in step S260), the content playback device 4 measures a corresponding network environment, and stores the measured network environmental data d40 in the network environmental data storage unit 406 in step S270.

Next, the content playback device 4 rearranges content providing servers 2 included in the server list L2 in order of playback priority in step S280. Here, the order of playback priority according to this embodiment roughly divides the server information d33 into the first group including content providing servers 2 with their original formats being maintained, and the second group including content providing servers 2 with their original formats being changed, and the priorities of the first group are higher than those of the second group.

Specifically, the content playback device 4 sets content providing servers 2 in the server information d33 to the first group; these content providing servers 2 have the formats identical to the original formats d32 included in the retrieval response, and sets the remaining content providing servers 2 to the second group; these remaining content providing servers 2 have the formats different from the original formats d32 included in the retrieval response.

Next, the content playback device 4 sorts the content providing servers 2 included in the first group in view of network environment in step S290. Specifically, the content playback device 4 sorts the content providing servers 2 included in the first group in descending order of their accessibilities from the content playback device 4 and their playback suitabilities.

For example, the content playback device 4 refers to corresponding values of the RTT of the network environmental data d40 to rearrange the content providing servers 2 in ascending order of their values of the RTT. Of course, rearrangement in view of network environment is not limited to the aforementioned method. For example, in place of or in addition to this method, rearrangement can be performed with reference to corresponding values of the hop count of the network data d40.

Next, the content playback device 4 sorts the content providing servers 2 included in the second group in view of image-quality and network environment in step S300. Specifically, the content playback device 4 sorts the content providing servers 2 included in the second group in descending order of: their image qualities, their accessibilities from the content playback device 4, and their playback suitabilities. Specifically, the priorities of the content providing servers 2 included in the second group are determined based on their weighted image qualities, accessibilities from the content playback device 4, and playback suitabilities.

Subsequently, the content playback device 4 selects a content providing server 2 corresponding to the server information d33 at the top of the server list L2, in other words, the server information d33 to which the highest priority is assigned in step S310.

Following step S310, the content playback device 4 accesses the selected content providing server 2 in accordance with the URL of the corresponding server information d33 to thereby determine whether it can access the content providing server 2 and whether it can obtain a corresponding video content from the accessed content providing server 2 in step S320.

If it can obtain a corresponding video content from the content providing server 2 (YES in step S320), the content playback server 4 obtains the corresponding video content in step S330, and plays back the obtained video content in step S340.

Otherwise, if cannot obtain a corresponding video content from the content providing server 2 (NO in step S320), the content playback server 4 deletes the content providing server 2 at the top of the server list L2 in step S350, and determines whether there is another server in the server list L2 in step S360.

If there is another server in the server list L2 (YES in step S360), the content playback server 4 returns to step S320, and selects the content providing server 2 at the top of the server list L2.

Otherwise, if there is not another server in the server list L2 (NO in step S360), the content playback server 4 displays an unplayable message on the screen thereof in step S370.

As described above, the content playback system 1 according to this embodiment uses the content mediation server 5 to simultaneously upload a video content to the content providing servers 2 by a single operation. This reduces users from registering video contents, and increases the degree of publicity (exposure) of video contents.

In addition, the content mediation server 5 of the content playback system 1 according to this embodiment stores therein the content registration data d30, which manages:

information associated with the access destination and format of each video content for each content providing server 2 to which a corresponding video content has been uploaded; and

the identical video contents uploaded to content providing servers 2 such that the identical video contents are correlated with each other.

As a result, a user can easily search for a content providing server 2 that stores therein a video content that is the same as a video content to be viewed by the user, and search for a content providing server 2 that stores therein a video content whose format is playable by the content playback device 4. That is, it is possible to retrieve video contents each stored in a plurality of video-sharing sites, thus facilitating identification of video contents each stored in a plurality of video-sharing sites.

The content playback device 4 of the content playback system 1 according to this embodiment sets priority in content providing servers 2, each of which stores therein a video content whose format is playable by the content playback device 4, according to: whether a corresponding format is converted, image quality, network environment, and so on. This can select an optimum content providing server 2 in view of playback, making it possible to play back video contents each with higher image quality.

In addition, uploading identical video contents to content providing servers 2 allows, even if there is a fault in any one of the content providing servers 2, one of the identical video contents to be obtained from another one of the content providing servers 2 and to be played back.

Note that, in this embodiment, the content playback device 4 creates a server list L2 to set priority in playable-content providing servers 2, but the content mediation server 5 can create a server list L2 to set priority in playable-content providing servers 2. Specifically, the content mediation server 5 selects an optimum content providing server 2, and informs the content playback device 4 that has transmitted a retrieval request of information associated with the selected content providing server 2. This modification can reduce the processing load of the content playback device 4. Note that, in this modification, a retrieval request includes information associated with formats playable by the content playback device 4, and the content playback device 4 stores therein the network environmental data d40.

In this embodiment, previously measured values of the RTT and/or the hop count are used as the network environmental data d40, but statistically processed values of communication data, such as communication rate, measured when a video content was uploaded to the content providing servers 2 can be used.

The content registration data d40 set forth above can be used for another purpose. For example, it is possible to easily find out duplicated identical video contents over a plurality of video-sharing sites.

The embodiment of the present invention has been described, but the present invention is not limited to the aforementioned embodiment. The embodiment of the present invention can be subjected to various deformations and modifications within the scope of the present invention. The embodiment with these various deformations and modifications are also within the scope of the present invention.

### DESCRIPTION OF CHARACTERS

1 Content playback system
2, 2a, 2b, 2n Content providing server
3 Content registration device
4 Content playback device
5 Content mediation server
6 Communication network
401 Request creator
402 Request transmitter
403 Response receiver
404 Response analyzer
405 Sever selector
406 Network environmental data storage unit
407 Network environment measuring unit
408 Content obtainer
409 Content data storage unit
410 Content playback unit
501 Request receiver
502 Request analyzer
503 Content converter/divider
504 Content uploading unit
505 Response transceiver
506 Content data storage unit
507 User data storage unit
508 Server data storage unit
509 Content registration data storage unit
d10 User data
d20 Server data
d30 Content registration data
d40 Network environmental data

1-10. (canceled)

11. A content mediation server mutually communicable with: a plurality of content providing servers for providing video contents; and a content playback device for playing back video contents provided from the plurality of content providing servers, via a communication network, the content mediation server comprising:
a server information storage means that stores therein, for each of the plurality of content providing servers, server information associated with: formats of video contents supported by a corresponding one of the plurality of content providing servers, and registration procedure with a corresponding one of the plurality of content providing servers;
a content registration means that refers to the server information stored in the server information storage means to collectively register a specified video content in each of the plurality of content providing servers;
a registration information storage means that stores therein registration information to be correlated with the specified video content, the registration information including a format and a registration-destination of the specified video content when the specified video content is collectively registered in each of the plurality of content providing servers;
a retrieval request receiving means that receives, from the content playback device, a retrieval request including identifying information for uniquely identifying a video content;
a retrieval means that refers to the registration information storage means based on the received retrieval request to obtain the registration information associated with the specified video content if the specified video content is identical to the video content identified by the identifying information; and
a retrieval response transmitting means that transmits, to the content playback device, the registration information obtained by the retrieval information as a retrieval response.

12. The content mediation server according to claim 11, wherein the content mediation server is mutually communicable, via the communication network, a content registration device that registers a video content in the plurality of content providing server, further comprising:
an upload request receiving means that receives an upload request from the content registration device, the upload request being configured to include the specified video content and request the content mediation server to collectively register the specified video content in each of the plurality of content providing means,
the content registration means collectively registering the specified video content in the plurality of content providing servers in response to receiving the upload request.

13. The content mediation server according to claim 11, wherein the identifying information is information associated with a registration-destination of the video content.

14. The content mediation server according to claim 11, wherein the identifying information is comprised of:
original format information of the specified video content;
format information of the specified video content when the specified video content is collectively registered in each of the plurality of content providing servers; and
a URL for accessing a location of each of the plurality of content providing servers in which the video content is registered.

15. The content mediation server according to claim 11, further comprising:
if the specified video content is registered in one of the plurality of content providing servers, a format conversion means that refers to the server information stored in the server information storage means, and converts a format of the specified video content into one of the formats supported by the one of the plurality of content providing servers upon determination that conversion of an original format of the specified content into one of the formats supported by the one of the plurality of content providing serves.

16. The content mediation server according to claim 11, wherein the retrieval request includes information associated with a format playable by the content playback device, and the registration information obtained by the retrieval means includes one or more content providing servers, further comprising:
a server select means that selects a content providing server in the one or more content providing servers included in the registration information obtained by the retrieval means according to the information associated with the playable format,
the retrieval response transmitting means transmitting, to the content playback device, the registration information associated with the selected content providing server.

17. The content mediation server according to claim 16, further comprising:
a network information obtaining means that obtains, from the content playback device, network information associated with accessibility of each of the plurality of content providing servers,
wherein the server select means selects the content providing server in consideration of the network information obtained by the network information means.

18. A content playback system comprising:
a plurality of content providing servers for providing video contents;
a content registration device for registering video contents in the plurality of content providing servers;
a content playback device for playing back video contents provided from the plurality of content providing servers; and
a content mediation server for mediating information between the plurality of content providing servers and the content registration device, and between the plurality of content providing servers and the content playback device, the plurality of content providing servers, the content registration device, the content registration device, and the content mediation server being mutually communicable with each other via a communication network,
wherein the content mediation server comprising:
an upload request receiving means that receives an upload request from the content registration device, the upload request being configured to include a specified video content and request the content mediation server to collectively register the specified video content in each of the plurality of content providing means;
a server information storage means that stores therein, for each of the plurality of content providing servers, server information associated with: formats of video contents supported by a corresponding one of the plurality of content providing servers, and registration procedure with a corresponding one of the plurality of content providing servers;
a content registration means that refers to the server information stored in the server information storage means when receiving the upload request to collectively register the specified video content in each of the plurality of content providing servers in response to receiving the upload request;
a registration information storage means that stores therein registration information to be correlated with the specified video content, the registration information including a format and a registration-destination of the specified video content when the specified video content is collectively registered in each of the plurality of content providing servers;
a retrieval request receiving means that receives, from the content playback device, a retrieval request including identifying information for uniquely identifying a video content;
a retrieval means that retrieves the registration information storage means according to the retrieval request, and obtains the registration information associated with the specified video content if the specified video content is identical to the video content identified by the identifying information; and
a retrieval response transmitting means that transmits, to the content playback device, the registration information obtained by the retrieval information as a retrieval response, and
the content playback device comprising:
a retrieval request transmitting means that transmits, to the content mediation server, the retrieval request;
a retrieval response receiving means that receives, from the content mediation server, the retrieval response;
a server select means that selects a content providing server in the plurality of content providing servers according to the registration information of the received retrieval response and a format playable by the content playback device; and
a content playback means that plays back a video content in the selected content providing server in accordance with the registration information of the selected content providing server.
